(19) United States
(12) Patent Application Publication
(10) Pub. No.: US 2019/0177030 A1
(43) Pub. Date: Jun. 13, 2019

(54) AN ELONGATED PACKAGE FOR A WINDSCREEN WIPER DEVICE OF THE FLAT BLADE TYPE

(71) Applicant: FEDERAL-MOGUL S.A., AUBANGE (BE)

(72) Inventor: OLIVIER BOULANGER, ETALLE (BE)

(21) Appl. No.: 16/301,590

(22) PCT Filed: Jun. 20, 2016
(86) PCT No.: PCT/EP2016/064213

§ 371 Date: Nov. 14, 2018

(51) Int. Cl. B65D 5/48; B60S 1/38; B65D 59/04

(52) U.S. Cl. CPC B65D 5/48014; B60S 1/3848; B60S 2001/3843; B65D 2585/6885; B65D 59/04

(57) ABSTRACT

An elongated package (12) for a windscreen wiper device of the flat blade type, with the special feature that the package has a quadrangular cross-section having four walls enclosing four vertices, wherein the package has an internal partition wall (13) extending along the length of the package, wherein the partition wall forms inside the package two chambers (16, 17) having along their length an at least substantially triangular cross-section, wherein each chamber is arranged to hold a windscreen wiper device (18, 19) of the flat blade type, and wherein at least one vertex (14, 15) of the triangular chambers has an acute angle.

### BACKGROUND

### 1. Technical Field

The present invention relates to an elongated package for a windscreen wiper device of the flat blade type.

The present invention also relates to a system comprising such an elongated package according to the invention, as well as two windscreen wiper devices of the flat blade type packaged therein.

### 2. Related Art

A windscreen wiper device of the flat blade type comprises an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, wherein ends of the wiper blade and/or of the longitudinal strip may be connected, if desired, with a respective connecting piece, the carrier element biasing the wiper blade in a curved position, which windscreen wiper device comprises a connecting device for pivotally connecting an oscillating wiper arm thereto near one end thereof. The longitudinal strip is usually referred to as a flexor, whereas the connecting piece is usually indicated as an end cap. The connecting device in practice is referred to as a connector. The wiper blade is preferably made by extrusion. Hence, the present windscreen wiper device is designed as a so-called “yokeless” wiper device, wherein use is no longer made of several yokes pivotally connected to each other, but wherein the wiper blade is biased by the carrier element, as a result of which it exhibits a specific curvature.

It is noted that the present invention is not restricted to the use of only one longitudinal strip forming the elastic carrier that is particularly located in a central longitudinal groove of the wiper blade. Instead, the carrier may also comprise two longitudinal strips, wherein the strips are disposed in opposite longitudinal grooves of the wiper blade. The groove(s) may be closed at one outer end.

Further, it is noted that in practice use is made of a mounting head fixed for rotation to a shaft, wherein the shaft is rotatable alternately in a clockwise and in a counter-clockwise sense carrying the mounting head into rotation. Thus, in turn the mounting head draws the connecting device into rotation and thereby moves the wiper blade. In the alternative, the mounting head is fixed for translation to a carriage, wherein the carriage can be translated alternately in a one linear direction and in another counter linear direction carrying the mounting head into translation. The present windscreen wiper device can therefore be used for circular or linear movement of the mounting head.

Such an elongated package is generally known.

One drawback of this known package is the fact that due its specific curvature the windscreen wiper device thereof cannot be inserted easily in the package, whereas once the windscreen wiper device is taken out the package it cannot be handled easily, for example in an outlet for display purposes. A further disadvantage is that it is expensive and cumbersome to make use of two packages for packaging two windscreen wiper devices with wiper blades having different lengths for a car.

### SUMMARY

The object of the invention is to overcome the drawbacks of the prior art as mentioned above, in particular to make it possible that the windscreen wiper device can be efficiently held during transport, storage and display.

In order to accomplish that objective, an elongated package of the kind referred to in the introduction is characterized according to the invention in that the package has a quadrangular cross-section having four walls enclosing four vertices (also referred to as corners), wherein the package has an internal partition wall extending along the length of the package, wherein the partition wall forms inside the package two chambers having along their length an at least substantially triangular cross-section, wherein each chamber is arranged to hold a windscreen wiper device of the flat blade type, and wherein at least one vertex of the triangular chambers has an acute angle. Thus, this package is shaped such that a windscreen wiper device of the flat blade packed therein is supported along its connecting device and/or its longitudinal strips and/or its connecting pieces, while a wiping lip thereof rests free inside towards a vertex of the respective chamber (i.e. is not engaged by the walls of the respective chamber). The present package allows packaging two windscreen wiper devices in the chambers, so that particularly two windscreen wiper devices with wiper blades having different lengths for one car can be efficiently transported, stored and displayed in one package. Further, as the triangular chambers each have at least one vertex with an acute angle preferably equal to or smaller than 45°, the windscreen wiper devices are supported inside the chambers at the location of their connecting devices and/or the connecting pieces, for example, without damaging a longitudinal wiping lip of the wiper blade thereof. Thus, the wiping lip is not engaged by the package and rests free inside the package. Wiping properties are therefore not negatively affected by using the package for transport, storage and display.

Particularly, the partition all extends along the entire length of the package.

It is noted that the present elongated package enveloping the two windscreen wiper devices is used without any further packages, so that the present package solely acts as holder during transport, storage and/or display.

In one preferred embodiment of an elongated package in accordance with the invention the partition wall encloses an acute angle equal to or smaller than 45° with an adjacent wall of the four walls of the quadrangular cross-section of the package. Particularly, the partition wall encloses an acute angle smaller than 40°, preferably smaller than 35°, more preferably smaller than 30° with an adjacent wall of the four walls of the quadrangular cross-section of the package.

In another preferred embodiment of an elongated package according to the invention the partition wall extends between opposite vertices of the quadrangular cross-section of the package.

In another preferred embodiment of an elongated package in accordance with the invention the package has a rectangular cross-section. In the alternative, the package has a rhombic cross-section or a trapezoidal cross-section.

In another preferred embodiment of an elongated package according to the invention the package and the partition wall are made in one piece of material. In the alternative, the partition wall is a separate constructional element. In the latter case the partition wall may then be slid inside the package. Preferably, the package and the partition wall are both made of a cellulose containing material, preferably cardboard.

As indicated, the present invention also refers to a system comprising an elongated package according to the present invention, as well as two windscreen wiper devices of the flat blade type, wherein one windscreen wiper device thereof is held by one of the chambers, and wherein the other windscreen wiper device thereof is held by the other of the chambers. Particularly, a wiping lip of each windscreen wiper device of the flat blade type is facing towards the acute angle.

### THE DRAWINGS

The invention will now be explained in more detail with reference to figures illustrated in a drawing, wherein:

FIG. 1 is a total perspective, schematic view of a windscreen wiper device of the flat blade type to be packaged in a package according to the invention;

FIG. 2 is a perspective, schematic view of a preferred embodiment of a box-like package in accordance with the invention, together with two windscreen wiper devices of the flat blade type ready to be packaged;

FIG. 3 corresponds to FIG. 2, but now sliding the windscreen wiper devices inside the package;

FIG. 4 corresponds to FIG. 3, but now the windscreen wiper devices being packaged (only one is visible); and

FIG. 5 is a schematic side view of the package of FIG. 4 showing that the packaged windscreen wiper devices are straightened inside the package.

### DETAILED DESCRIPTION

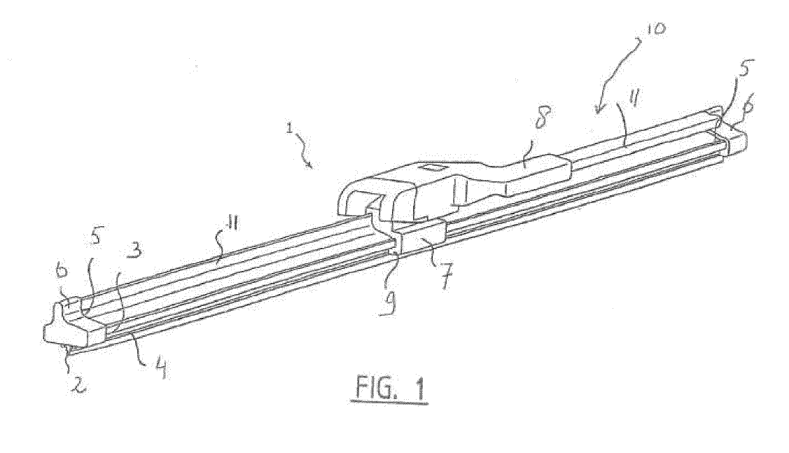

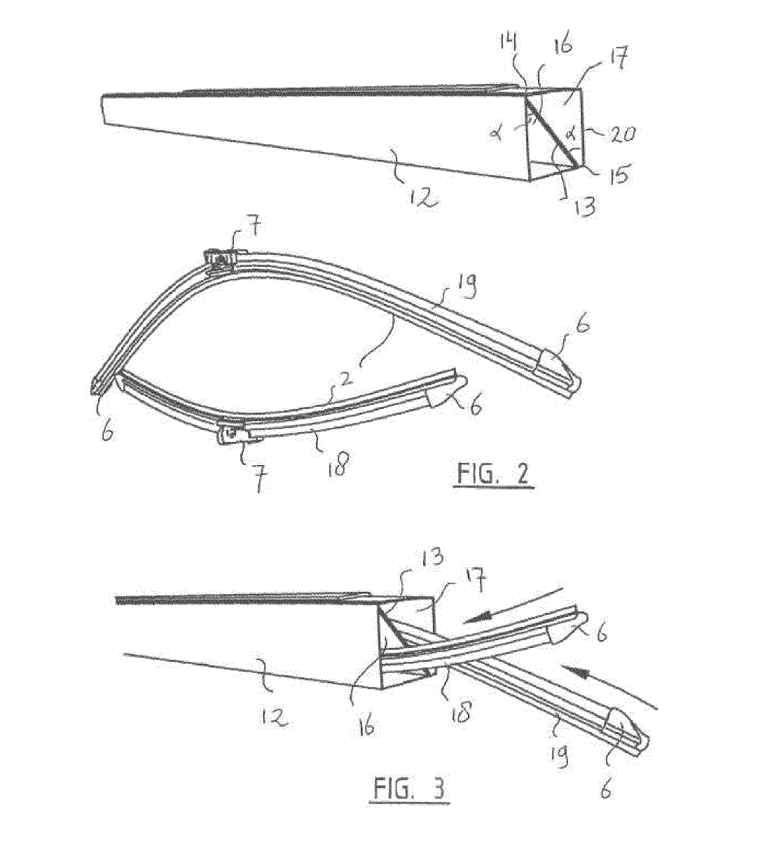

FIG. 1 shows a preferred variant of a windscreen wiper device 1 of the flat blade type. The windscreen wiper device is built up of an elastomeric wiper blade 2, in the longitudinal sides of which opposing longitudinal grooves 3 are formed, and of longitudinal strips 4 made of spring band steel, which are fitted in the longitudinal grooves 3. The strips 4 form a flexible carrier element for the rubber wiper blade 2, as it were, which is thus biased in a curved position (the curvature in operative position being that of a windscreen to be wiped). Neighboring ends 5 of strips 4 are interconnected on either side of the windscreen wiper device 1 by means of connecting pieces 6 or end caps functioning as clamping members. In this embodiment, the connecting pieces 6 are separate constructional elements, which may be form-locked as well as force-locked to the ends 5 of strips 4. In another preferred variant, The connecting pieces 6 are in one piece with the strips 4 made of spring band steel. In the latter case the connecting pieces form transverse bridges for the strips 4, as it were. The windscreen wiper device 1 is furthermore built up of a connecting device 7 of plastic or metallic material for an oscillating wiper arm 8. Connecting device 7 comprises clamping members 9 that are integral therewith, which engage round longitudinal sides of the strips 4 that face away from each other, as a result of which the connecting device 7 is firmly attached to the unit consisting of wiper blade 2 and strips 4. The oscillating wiper arm 8 is pivotally connected to the connecting device 7 about a pivot axis near one end. A spoiler or “air deflector” 10 is included and comprises two separate sub-spoilers 11. Each sub-spoiler 11 is detachably connected in its entirety to the wiper blade 2 on opposite sides of the connecting device 7. In FIG. 2 an elongated box-like package 12 having a rectangular cross-section is depicted. The package 12 is made from one blank and is made entirely of cardboard. As shown, the package 12 has a partition wall 13 in one piece thereof. The partition wall 13 extends along the entire length of the package 12 and between opposite vertices 14,15 of the package 12. This partition wall 13 divides the internal space inside the package 12 into two chambers 16,17 having a triangular cross-section along their entire length. Each chamber 16,17 is arranged to receive and accommodate a windscreen wiper device 18,19 of the fiat blade type. This is shown in FIG. 3, wherein these windscreen wiper devices 18,19 are slid in longitudinal direction inside their corresponding chambers 16,17.

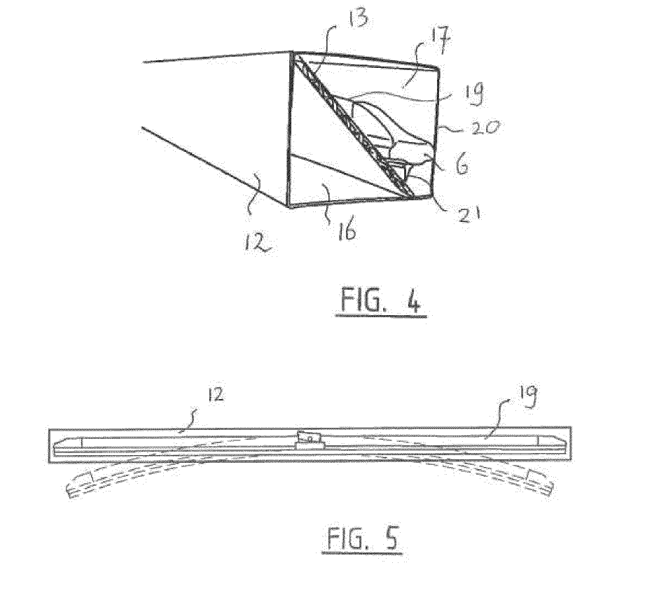

With reference to FIG. 4, the partition wall 13 encloses an acute angle a smaller than 45° with an adjacent wall 20 of the boxlike package 12, so that the windscreen wiper device 19 shown is supported inside its corresponding chamber 17 at the location of its connecting device 7 and/or its connecting pieces 6, and so that a wiping lip 21 of the wiper blade 2 thereof is not engaged at all. The wiping lip 21 rests thus free inside the chamber 17 and cannot be damaged during transport, for example. The other windscreen wiper device 18 (not shown) would be inside its corresponding chamber 16 in a position upside down compared to the windscreen wiper device 19, as depicted in FIG. 3.

As shown in FIG. 5, the windscreen wiper devices 18,19 are stretched, i.e. straightened inside their corresponding chambers 16,17, seen relative to their curved position prior to insertion in the package in FIG. 2 (shown in dotted lined ire FIG. 5).

The present invention is not restricted to the embodiment shown, but also covers other preferred embodiments falling under the scope of the appended claims.

1. An elongated package for a windscreen wiper device of the flat blade type, comprising a quadrangular cross-section of said package having four walls enclosing four vertices, wherein said package has an internal partition wall extending along the length of the package, wherein said partition wall forms inside said package two chambers having along their length an at least substantially triangular cross-section, wherein each chamber is arranged to hold a windscreen wiper device of the flat blade type, and wherein at least one vertex of said triangular chambers has an acute angle α.

2. An elongated package according to claim 1, wherein said partition wall encloses an acute angle a smaller than 45° with an adjacent wall of said four walls of said quadrangular cross-section of said package.

3. An elongated package according to claim 1, wherein said partition wall extends between opposite vertices of said quadrangular cross-section of said package.

4. An elongated package according to claim 1, wherein said partition wall encloses an acute angle a equal to or smaller than 45° with an adjacent wall of said four walls of said quadrangular cross-section of said package.

5. An elongated package according to claim 1, wherein said partition wall encloses an acute angle a smaller than 35° with an adjacent wall of said four walls of said quadrangular cross-section of said package.

6. An elongated package according to claim 1, wherein said partition wall encloses an acute angle a smaller than 30° with an adjacent wall of said four walls of said quadrangular cross-section of said package.

7. An elongated package according to claim 1, wherein said package has a rectangular cross-section.

8. An elongated package according to claim 1, wherein said package has a rhombic cross-section.

9. An elongated package according to claim 1, wherein said package has a trapezoidal cross-section.

10. An elongated package according to claim 1, wherein said package and said partition wall are made in one piece of material.

11. An elongated package according to claim 1, wherein said partition wall is a separate constructional element.

12. An elongated package according to claim 1, wherein said package and said partition wall are made of a cellulose containing material, preferably cardboard.

13. A packaged wiper blade assembly comprising an elongated package according to claim 1, as well as two windscreen wiper devices of the flat blade type, wherein one windscreen wiper device thereof is held by one of said chambers, and wherein the other windscreen wiper device thereof is held by the other of said chambers.

14. The packaged wiper blade assembly according to claim 13, wherein a wiping lip of each windscreen wiper device of the flat blade type is facing towards said acute angle α.

15. The elongated package of claim 4, wherein the acute angle α is less than 40°.
